(19) United States
(12) Patent Application Publication
(10) Pub. No.: US 2023/0236614 A1
(43) Pub. Date: Jul. 27, 2023

(54) A METHOD FOR CONTROLLING THE COOLANT FLOW OF LIQUID-COOLED POWER BATTERY, SYSTEM, AND VEHICLE

(71) Applicant: GAC AION NEW ENERGY AUTOMOBILE CO., LTD., Guangzhou, Guangdong (CN)

(72) Inventors: Dan Wei, Guangzhou (CN); Linpei Zhu, Guangzhou (CN); Yuxiang Chen, Guangzhou (CN); Xiong Zhang, Guangzhou (CN)

(21) Appl. No.: 17/928,578

(22) PCT Filed: Jun. 4, 2021
(86) PCT No.: PCT/CN2021/098342

§ 371 Date: Nov. 29, 2022

(30) Foreign Application Priority Data
Jun. 11, 2020 (CN) 202010528311.0

(51) Int. Cl. G05D 7/06; H01M 10/633; G05B 19/416

(52) U.S. Cl. CPC G05D 7/0676; H01M 10/633; G05D 7/0623; G05B 19/416; G05B 2219/37371

(57) ABSTRACT

The present disclosure provides a method for controlling the coolant flow of a liquid-cooled power battery, a system, and a vehicle. The method obtains a relationship between a temperature difference within a battery pack and a temperature difference within the coolant, and deduces a target temperature difference within the coolant according to a target temperature difference within the battery pack and the relationship between the temperature difference within the battery pack and the temperature difference within the coolant. The method determines a required flow capacity of the coolant according to the target temperature difference within the coolant, and controls a battery cooling pump to operate according to the required flow capacity of the coolant. The problem of higher energy consumption existing in existing liquid-cooled battery packs for controlling the temperature difference within the battery pack is resolved by the disclosure.

### CROSS-REFERENCE TO RELATED APPLICATIONS

This application is a continuation of International Patent Application No. PCT/CN2021/098342, filed on Jun. 4, 2021, which claims priority to Chinese Patent Application No. 202010528311.0, filed on Jun. 11, 2020, both of which are hereby incorporated by reference in their entireties.

### FIELD

The subject matter herein generally relates to vehicle technology, and particularly to a method for controlling the coolant flow of a liquid-cooled power battery, a system, and a vehicle.

### BACKGROUND

Existing new energy battery packs use liquid-cooled means. A flow capacity and a temperature control of the new energy battery pack can be controlled according to a detected battery temperature and a detected coolant temperature. The flow capacity and the temperature of the coolant in the liquid-cooled battery pack influence the heat exchange capability of the coolant. Thus, a rate of change of temperature of the battery as the battery pack is heated and cooled is affected, and a temperature difference between the coolant at an inlet and the coolant at an outlet is also affected. The temperature difference directly reflects the energy carried away by the coolant or the energy lost from the coolant. The greater the temperature difference between the coolant at the inlet and the coolant at the outlet, the greater the temperature difference of the interior of the battery pack is generated by the coolant. To ensure a smaller temperature difference between the coolant at the inlet and the coolant at the outlet, the pump needs to provide a higher flow capacity of the coolant, thus resulting in a higher energy consumption.

### SUMMARY

An embodiment of the present application provides a method for controlling the coolant flow of a liquid-cooled power battery, a system, and a vehicle, which are capable of resolving a problem of higher energy consumption caused by the existing liquid-cooled battery pack for controlling a temperature difference within the battery pack.

An embodiment of the present application provides a method for controlling the coolant flow of a liquid-cooled power battery. The method includes:

Step S11: obtaining a relationship between a temperature difference within a battery pack and a temperature difference within the coolant;

Step S12: deducing a target temperature difference within the coolant according to a target temperature difference within the battery pack and the relationship between the temperature difference within the battery pack and the temperature difference within the coolant;

Step S13: determining a required flow capacity of the coolant according to the target temperature difference within the coolant;

Step S14: controlling a battery cooling pump to operate according to the required flow capacity of the coolant.

Further, the Step S11 includes:

Applying a three-dimensional computational fluid dynamics simulation analysis or a thermal management test to obtain the relationship between the temperature difference within the battery pack and the temperature difference within the coolant.

Further, the Step S13 includes:

Establishing a first formula according to a relationship between a heat transfer thermal resistance of the battery pack and the flow capacity of the coolant, wherein the first formula is

$${R}_{batt \_ co} = \frac{Δ {T}_{batt \_ co}}{{Q}_{c o} {ρ}_{c o} Δ {T}_{in \_ out} {c}_{p}} ,$$

wherein R_{batt_co} is the heat transfer thermal resistance of the battery pack, ΔT_{batt_co} is a difference between a temperature of the battery pack and a temperature of the coolant, Q_{co} is the flow capacity of the coolant, ρ_{co} is a density of the coolant, ΔT_{in_out} is the temperature difference within the coolant, and cₚ is a specific heat of the coolant;

Generating a second formula of the heat transfer thermal resistance of the battery pack and a mass flow rate of the coolant via fitting by applying a relationship between the heat transfer thermal resistance of the batter pack and the mass flow rate of the coolant generated by a simulation or an experiment, wherein the second formula is

$${R}_{batt \_ co} = a \frac{1}{m} + b \frac{1}{{m}^{2}} + c ,$$

wherein m is the mass flow rate of the coolant, and a, b, and c are coefficients;

Determining a required flow capacity of the coolant according to a combination of the first formula, the second formula, the target temperature difference within the coolant, a temperature of the battery pack obtained by a test, and a temperature of the coolant obtained by the test.

Further, determining the required flow capacity of the coolant according to a combination of the first formula, the second formula, the target temperature difference within the coolant, the temperature of the battery pack obtained by the test, and the temperature of the coolant obtained by the test includes:

Making A=ccₚΔT_{co_max}, B=acₚΔT_{co_max}−T_{batt}+T_{coolant}, and C=bcₚΔT_{co_max}, wherein ΔT_{co_max} is the target temperature difference within the coolant, T_{batt} is the temperature of the battery pack obtained by the test, and T_{coolant} is the temperature of the coolant obtained by the test;

Determining a formula of a required mass flow rate of the coolant to be

$${m}_{r e q} = \frac{- B + \sqrt{{B}^{2} - 4 A C}}{2 A} ;$$

Determining a formula of the required flow capacity of the coolant according to the required mass flow rate of the coolant and the density of the coolant, wherein the formula of the required flow capacity of the coolant is

$${Q}_{r e q} = \frac{{m}_{r e q}}{{ρ}_{c o}} ,$$

wherein Q_{req} is the required flow capacity of the coolant.

An embodiment of the present application provides a system for controlling the coolant flow of a liquid-cooled power battery. The system includes:

An obtaining unit being configured to obtain a relationship between a temperature difference within a battery pack and a temperature difference within the coolant;

A first determining unit being configured to deduce a target temperature difference within the coolant according to a target temperature difference within the battery pack and the relationship between the temperature difference within the battery pack and the temperature difference within the coolant;

A second determining unit being configured to determine a required flow capacity of the coolant according to the target temperature difference within the coolant;

A control unit being configured to control a battery cooling pump to operate according to the required flow capacity of the coolant.

Further, the obtaining unit is configured to:

Apply a three-dimensional computational fluid dynamics simulation analysis or a thermal management test to obtain the relationship between the temperature difference within the battery pack and the temperature difference within the coolant.

Further, the second determining unit is configured to:

Establish a first formula according to a relationship between a heat transfer thermal resistance of the battery pack and the flow capacity of the coolant, wherein the first formula is

$${R}_{batt \_ co} = \frac{Δ {T}_{batt \_ co}}{{Q}_{c o} {ρ}_{c o} Δ {T}_{in \_ out} {c}_{p}} ,$$

wherein R_{batt_co} is the heat transfer thermal resistance of the battery pack, ΔT_{batt_co} is a difference between a temperature of the battery pack and a temperature of the coolant, Q_{co} is the flow capacity of the coolant, ρ_{co} is a density of the coolant, ΔT_{in_out} is the temperature difference within the coolant, and cₚ is a specific heat of the coolant;

Generate a second formula of the heat transfer thermal resistance of the battery pack and a mass flow rate of the coolant via fitting by applying a relationship between the heat transfer thermal resistance of the batter pack and the mass flow rate of the coolant established by a simulation or an experiment, wherein the second formula is

$${R}_{batt \_ co} = a \frac{1}{m} + b \frac{1}{{m}^{2}} + c ,$$

wherein m is the mass flow rate of the coolant, and a, b, and c are coefficients;

Determine a required flow capacity of the coolant according to a combination of the first formula, the second formula, the target temperature difference within the coolant, a temperature of the battery pack obtained by a test, and a temperature of the coolant obtained by the test.

An embodiment of the present application provides a vehicle. The vehicle includes the system for controlling the coolant flow of a liquid-cooled power battery.

The disclosure has the following beneficial effects:

The disclosure determines the target temperature difference within the coolant according to the target temperature difference within the battery pack and the relationship between the temperature difference within the battery pack and the temperature difference within the coolant. The disclosure further determines the required flow capacity of the coolant according to the target temperature difference within the coolant and controls an operation of the battery cooling pump according to the required flow capacity of the coolant. Thus, the problem of the higher energy consumption caused by the existing liquid-cooled battery packs for controlling the temperature difference within the battery pack is resolved.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a flowchart of a method for controlling the coolant flow of a liquid-cooled power battery according to the present disclosure.

FIG. 2 is a curve graph showing a relationship between a temperature difference within a battery pack and a temperature difference within the coolant according to the present disclosure.

FIG. 3 is a graph showing a relationship between a heat transfer thermal resistance of a battery pack and a mass flow rate of the coolant according to the present disclosure.

FIG. 4 is a structural diagram of a system for controlling the coolant flow of a liquid-cooled power battery according to the present disclosure.

### DETAILED DESCRIPTION

The disclosure controls the flow capacity of the coolant on the premise of guaranteeing a temperature difference within the battery pack being less than or equal to a target temperature difference in the battery pack. The disclosure will be further described with reference to the accompanying drawing and the embodiments.

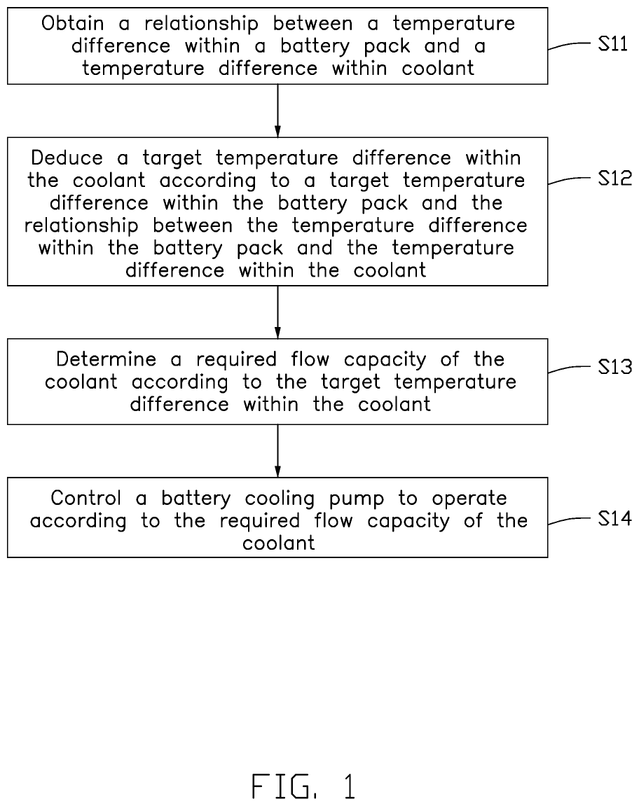

FIG. 1 is a flowchart of a method for controlling the coolant flow of a liquid-cooled power battery according to the present disclosure. The method includes:

Step S11: obtaining a relationship between a temperature difference within a battery pack and a temperature difference within the coolant.

It is important to note that, the temperature difference within the battery pack is the temperature difference between the battery cells. The temperature difference within the battery pack needs to be limited within a preset range, otherwise an operation of a vehicle employing the power battery may be influenced. The temperature difference within the coolant is a difference between a temperature of the coolant at the coolant outlet of the battery pack and a temperature of the coolant at the inlet of the battery pack. Due to a heat exchange between the battery coolant and the battery pack, a difference is existed between the temperature of the coolant at the inlet of the battery pack and the temperature of the coolant at the outlet of the battery pack.

In detail, a three-dimensional computational fluid dynamics simulation analysis or a thermal management test is applied to obtain the relationship between the temperature difference within the battery pack and the temperature difference within the coolant.

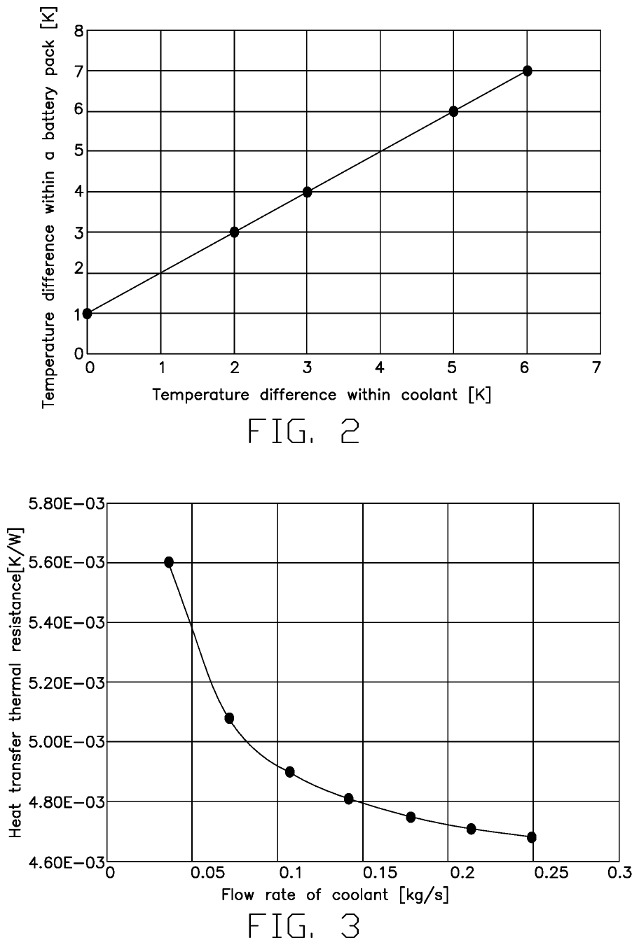

Referring also to FIG. 2, FIG. 2 shows a linear relationship between the temperature difference within the battery pack and the temperature difference within the coolant. Although FIG. 2 employs a straight line to show the relationship between the temperature difference within the battery pack and the temperature difference within the coolant, however according to different types of battery packs, the relationship between the temperature difference within the battery pack and the temperature difference within the coolant can be a curving line.

Step S12: deducing a target temperature difference within the coolant according to a target temperature difference within the battery pack and the relationship between the temperature difference within the battery pack and the temperature difference within the coolant.

It is important to note that, the target temperature difference within the battery pack represents a greatest temperature difference within the battery pack. However, if the temperature difference within the battery pack is greater than the target temperature difference within the battery pack, an operating efficiency of the battery pack may be decreased. Each battery pack has its own target temperature difference within the battery pack. The disclosure deduces the target temperature difference within the coolant according to the target temperature difference within the battery pack and the relationship between the temperature difference within the battery pack and the temperature difference within the coolant. Thus, the temperature difference within the coolant must be controlled to be within the preset range, otherwise temperature difference within the battery pack may be caused to be too large.

Step S13: determining a required flow capacity of the coolant according to the target temperature difference within the coolant.

It is important to note that, a limitation of the target temperature difference within the coolant causes that, flow capacity of the coolant of the liquid-cooled power battery can be increased. However, the flow capacity should be minimized if the flow capacity is on the premise of ensuring being within the target temperature difference within the coolant.

The Step S13 includes:

Establishing a first formula according to a relationship between a heat transfer thermal resistance of the battery pack and the flow capacity of the coolant, wherein the first formula is

$${R}_{batt \_ co} = \frac{Δ {T}_{batt \_ co}}{{Q}_{c o} {ρ}_{c o} Δ {T}_{in \_ out} {c}_{p}} ,$$

wherein R_{batt_co} is the heat transfer thermal resistance of the battery pack, ΔT_{batt_co} is a difference between a temperature of the battery pack and a temperature of the coolant, Q_{co} is the flow capacity of the coolant, ρ_{co} is a density of the coolant, ΔT_{in_out} is the temperature difference within the coolant, and cₚ is a specific heat of the coolant;

It is important to note that, the equation as to heat transfer thermal resistance in the first formula is established based on a theoretical concept.

Simulating or experimenting to establish a relationship between the heat transfer thermal resistance of the batter pack and a mass flow rate of the coolant, and generating a second formula of the heat transfer thermal resistance of the battery pack and the mass flow rate of the coolant via fitting, wherein the second formula is

$${R}_{batt \_ co} = a \frac{1}{m} + b \frac{1}{{m}^{2}} + c ,$$

wherein m is the mass flow rate of the coolant, and a, b, and c are coefficients;

It is important to note that, the equation in the second formula is the relationship between the heat transfer thermal resistance of the battery pack and the mass flow rate of the coolant which is generated via fitting based on test data, and the detail can refer to FIG. 3. The curve expression generated via fitting is the second formula, and a, b, and c in the fitted second formula are constants.

Determining a required flow capacity of the coolant according to a combination of the first formula, the second formula, the target temperature difference within the coolant, a temperature of the battery pack obtained by a test, and a temperature of the coolant obtained by the test.

In detail, the determining of the required flow capacity of the coolant includes:

Making A=ccₚΔT_{co_max}, B=acₚΔT_{co_max}−T_{batt}+T_{coolant}, and C=bcₚΔT_{co_max}, wherein ΔT_{co_max} is the target temperature difference within the coolant, T_{batt} is the temperature of the battery pack obtained by the test, and T_{coolant} is the temperature of the coolant obtained by the test;

Determining a formula of a required mass flow rate of the coolant to be

$${m}_{r e q} = \frac{- B + \sqrt{{B}^{2} - 4 A C}}{2 A} ;$$

Determining a formula of the required flow capacity of the coolant according to the required mass flow rate of the coolant and the density of the coolant, wherein the formula of the required flow capacity of the coolant is

$${Q}_{r e q} = \frac{{m}_{r e q}}{{ρ}_{c o}} ,$$

wherein Q_{req} is the required flow capacity of the coolant.

Step S14: controlling a battery cooling pump to operate according to the required flow capacity of the coolant.

It is important to note that, on the premise of guaranteeing the temperature difference within the battery pack being less than or equal to the target temperature difference within the battery pack, the disclosure can control the battery cooling pump to operate according to the determined required flow capacity of the coolant, an effect of minimizing the energy consumption can be achieved.

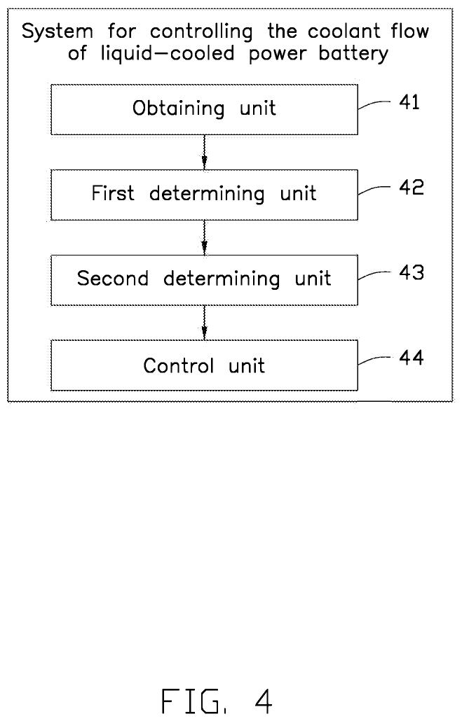

FIG. 4 is a structural diagram of a system for controlling the coolant flow of a liquid-cooled power battery according to the present disclosure. The system includes:

An obtaining unit 41 being configured to obtain a relationship between a temperature difference within a battery pack and a temperature difference within the coolant;

A first determining unit 42 being configured to deduce a target temperature difference within the coolant according to a target temperature difference within the battery pack and the relationship between the temperature difference within the battery pack and the temperature difference within the coolant;

A second determining unit 43 being configured to determine a required flow capacity of the coolant according to the target temperature difference within the coolant;

A control unit 44 being configured to control a battery cooling pump to operate according to the required flow capacity of the coolant.

Further, the obtaining unit 41 is configured to:

Apply a three-dimensional computational fluid dynamics simulation analysis or a thermal management test to obtain the relationship between the temperature difference within the battery pack and the temperature difference within the coolant.

Further, the second determining unit 43 is configured to:

Establish a first formula according to a relationship between a heat transfer thermal resistance of the battery pack and the flow capacity of the coolant, wherein the first formula is

$${R}_{batt \_ co} = \frac{Δ {T}_{batt \_ co}}{{Q}_{c o} {ρ}_{c o} Δ {T}_{in \_ out} {c}_{p}} ,$$

wherein R_{batt_co} is the heat transfer thermal resistance of the battery pack, ΔT_{batt_co} is a difference between a temperature of the battery pack and a temperature of the coolant, Q_{co} is the flow capacity of the coolant, ρ_{co} is a density of the coolant, ΔT_{in_out} is the temperature difference within the coolant, and cₚ is a specific heat of the coolant;

Generate a second formula of the heat transfer thermal resistance of the battery pack and a mass flow rate of the coolant via fitting by applying a relationship between the heat transfer thermal resistance of the batter pack and the mass flow rate of the coolant established by a simulation or an experiment, wherein the second formula is

$${R}_{batt \_ co} = a \frac{1}{m} + b \frac{1}{{m}^{2}} + c ,$$

wherein m is the mass flow rate of the coolant, and a, b, and c are coefficients;

Determine a required flow capacity of the coolant according to a combination of the first formula, the second formula, the target temperature difference within the coolant, a temperature of the battery pack obtained by a test, and a temperature of the coolant obtained by the test.

An embodiment of the present application provides a vehicle. The vehicle includes the system for controlling the coolant flow of a liquid-cooled power battery.

The disclosure has the following beneficial effects:

The disclosure determines the target temperature difference within the coolant according to the target temperature difference within the battery pack and the relationship between the temperature difference within the battery pack and the temperature difference within the coolant. The disclosure further determines the required flow capacity of the coolant according to the target temperature difference within the coolant and controls an operation of the battery cooling pump according to the required flow capacity of the coolant. Thus, the problem of the higher energy consumption caused by the existing liquid-cooled battery packs for controlling the temperature difference within the battery pack is resolved.

The present disclosure is described in detail in accordance with the above contents with the specific exemplary examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong within the protection scope of the present disclosure.

1. A method for controlling the coolant flow of a liquid-cooled power battery, the method comprising:
step S11: obtaining a relationship between a temperature difference within a battery pack and a temperature difference within the coolant;
step S12: deducing a target temperature difference within the coolant according to a target temperature difference within the battery pack and the relationship between the temperature difference within the battery pack and the temperature difference within the coolant;
step S13: determining a required flow capacity of the coolant according to the target temperature difference within the coolant; and
step S14: controlling a battery cooling pump to operate according to the required flow capacity of the coolant.

2. The method according to claim 1, wherein the step S11 comprises:
applying a three-dimensional computational fluid dynamics simulation analysis or a thermal management test to obtain the relationship between the temperature difference within the battery pack and the temperature difference within the coolant.

3. The method according to claim 1, wherein the step S13 comprises:
establishing a first formula according to a relationship between a heat transfer thermal resistance of the battery pack and the flow capacity of the coolant, wherein the first formula is
$${R}_{batt \_ co} = \frac{Δ {T}_{batt \_ co}}{{Q}_{c o} {ρ}_{c o} Δ {T}_{in \_ out} {c}_{p}} ,$$
wherein R_{batt_co} is the heat transfer thermal resistance of the battery pack, ΔT_{batt_co} is a difference between a temperature of the battery pack and a temperature of the coolant, Q_{co} is the flow capacity of the coolant, ρ_{co} is a density of the coolant, ΔT_{in_out} is the temperature difference within the coolant, and cₚ is a specific heat of the coolant;
generating a second formula of the heat transfer thermal resistance of the battery pack and a mass flow rate of the coolant via fitting by applying a relationship between the heat transfer thermal resistance of the batter pack and the mass flow rate of the coolant established by a simulation or an experiment, wherein the second formula is
$${R}_{batt \_ co} = a \frac{1}{m} + b \frac{1}{{m}^{2}} + c ,$$
wherein m is the mass flow rate of the coolant, and a, b, and c are coefficients; and
determining a required flow capacity of the coolant according to a combination of the first formula, the second formula, the target temperature difference within the coolant, a temperature of the battery pack obtained by a test, and a temperature of the coolant obtained by the test.

4. The method according to claim 3, wherein determining the required flow capacity of the coolant according to the combination of the first formula, the second formula, the target temperature difference within the coolant, the temperature of the battery pack obtained by the test, and the temperature of the coolant obtained by the test comprises:
making A=ccₚΔT_{co_max}, B=acₚΔT_{co_max}−T_{batt}+T_{coolant}, and C=bcₚΔT_{co_max}, wherein ΔT_{co_max} is the target temperature difference within the coolant, T_{batt} is the temperature of the battery pack obtained by the test, and T_{coolant} is the temperature of the coolant obtained by the test;
determining a formula of a required mass flow rate of the coolant to be
$${m}_{r e q} = \frac{- B + \sqrt{{B}^{2} - 4 A C}}{2 A} ;$$
determining a formula of the required flow capacity of the coolant according to the required mass flow rate of the coolant and the density of the coolant, wherein the formula of the required flow capacity of the coolant is
$${Q}_{req} = \frac{{m}_{r e q}}{{ρ}_{c o}} ,$$
wherein Q_{req} is the required flow capacity of the coolant.

5-10. (canceled)
